(19) United States
(12) Patent Application Publication
(10) Pub. No.: US 2017/0017766 A1
(43) Pub. Date: Jan. 19, 2017

(54) HEALTH-AWARE CAR ACCIDENT TELEMATICS

(71) Applicant: MOJ.IO INC., North Vancouver (CA)

(72) Inventor: DAMON GIRAUD, NORTH VANCOUVER (CA)

(73) Assignee: MOJ.IO INC., NORTH VANCOUVER (CA)

(21) Appl. No.: 14/802,732

(22) Filed: Jul. 17, 2015

(51) Int. Cl. G06F 19/00; H04W 4/04

(52) U.S. Cl. CPC G06F 19/3418; H04W 4/046; G06F 19/322

(57) ABSTRACT

Personal electronic devices may be wirelessly detected within wireless range of a vehicle. One or more of the passengers may be identified based on an association of each passenger with a respective personal electronic device that was wirelessly detected. Sensor information is received from one or more sensors located on-board the vehicle, and a crash event involving the vehicle is detected based on the sensor information. For each passenger identified on-board the vehicle, physiological measurement information is obtained for that passenger measured by one or more sensors of the personal electronic device of that passenger during the crash event and/or during a post-crash period of time following the crash event. Responsive to detecting the crash event, a set of one or more crash event reporting messages, including the physiological measurement information, are transmitted over a communications network directed to a target recipient.

### BACKGROUND

Many modern vehicles include on-board electronic control systems that manage, measure, and report operation of the vehicle's various subsystems. On-board electronic control systems may include or otherwise support on-board diagnostic (OBD) services that enable vehicle owners and repair technicians to access diagnostic information or other forms of operational information from the control system. As one example, on-board electronic control systems of a vehicle may be accessed via a data interface in the form of a physical wired data link connector or data port. OBD information may be communicated over this data interface using a variety of protocols, including ALDL, OBD-I, OBD-1.5, OBD-II, etc.

### SUMMARY

Personal electronic devices may be wirelessly detected within wireless range of a vehicle. One or more of the passengers may be identified based on an association of each passenger with a respective personal electronic device that was wirelessly detected. Sensor information is received from one or more sensors located on-board the vehicle, and the occurrence of a crash event involving the vehicle is detected based on the sensor information. For each passenger identified on-board the vehicle, physiological measurement information is obtained for that passenger measured by one or more sensors of the personal electronic device of that passenger during the crash event and/or during a post-crash period of time following the crash event. Other health related data collected e.g., via manual input from the user is stored in the cloud and also sent to health authorities.

Responsive to detecting the crash event, a set of one or more crash event reporting messages are transmitted over a communications network directed to a target recipient. The set of crash event reporting messages may include the physiological measurement information obtained for each passenger identified on-board the vehicle, and may include additional information. The target recipient may include emergency services and/or law enforcement services (as well as insurance companies or legal services companies) or a service responsible for receiving communications on-behalf of emergency services and/or law enforcement services.

This summary includes only some of the concepts disclosed in greater detail by the following detailed description and associated drawings. As such, claimed subject matter is not limited to the contents of this summary.

### BRIEF DESCRIPTION OF DRAWINGS

FIG. 1 is a schematic diagram depicting an example computing system.

FIG. 2 is a flow diagram depicting an example method that may be performed by a computing system.

FIGS. 3-6 are flow diagrams depicting example interactions between several electronic devices of a computing system.

FIG. 7 is a schematic diagram depicting additional aspects of an example computing system.

### DETAILED DESCRIPTION

The occurrence of a vehicular accident (i.e., crash) may be detected based on sensor measurements obtained from a variety of sources, including: (1) sensors integrated with a passenger's personal electronic device carried on-board the vehicle, (2) sensors integrated with an on-board interface device that interfaces with an on-board diagnostics service of the vehicle via an on-board diagnostics interface, and/or (3) sensors integrated with the vehicle that report measurements to the on-board interface device via the on-board diagnostics interface.

During an initial device detection and/or passenger identification phase, wireless devices within wireless range of the vehicle may be detected and/or passengers may be identified that are associated with the wireless devices or otherwise indicated as being present on-board the vehicle. During a crash event detection phase, sensor measurements obtained from various sources are processed and analyzed to detect occurrence of a crash event involving the vehicle.

Following detection of the crash event involving the vehicle, a set of one or more crash event reporting messages are transmitted over a communications network, directed to a target recipient. The target recipient may include a cloud-based service, insurance companies, legal services companies, emergency services, law enforcement services, or a service that processes emergency communications on-behalf of emergency services and/or law enforcement services. Reporting messages may include: (1) physiological measurement information for the passengers measured by sensors of the passenger's personal electronic devices before, during, and/or after the crash event, (2) information describing a state of the vehicle before, during, and/or after the crash event, and/or (3) passenger profile information, such as pre-defined biographical and/or medical records information (including health related data collected e.g., via manual input from the user).

Information contained in reporting messages may enable emergency services and/or law enforcement services to more effectively locate, rescue, and administer medical treatment to passengers. During a post-crash communication phase, communications are established between the target recipient (or other suitable party) and one or more passengers of the vehicle, enabling emergency services and/or law enforcement services to obtain additional information from passenger or provide additional information to passengers.

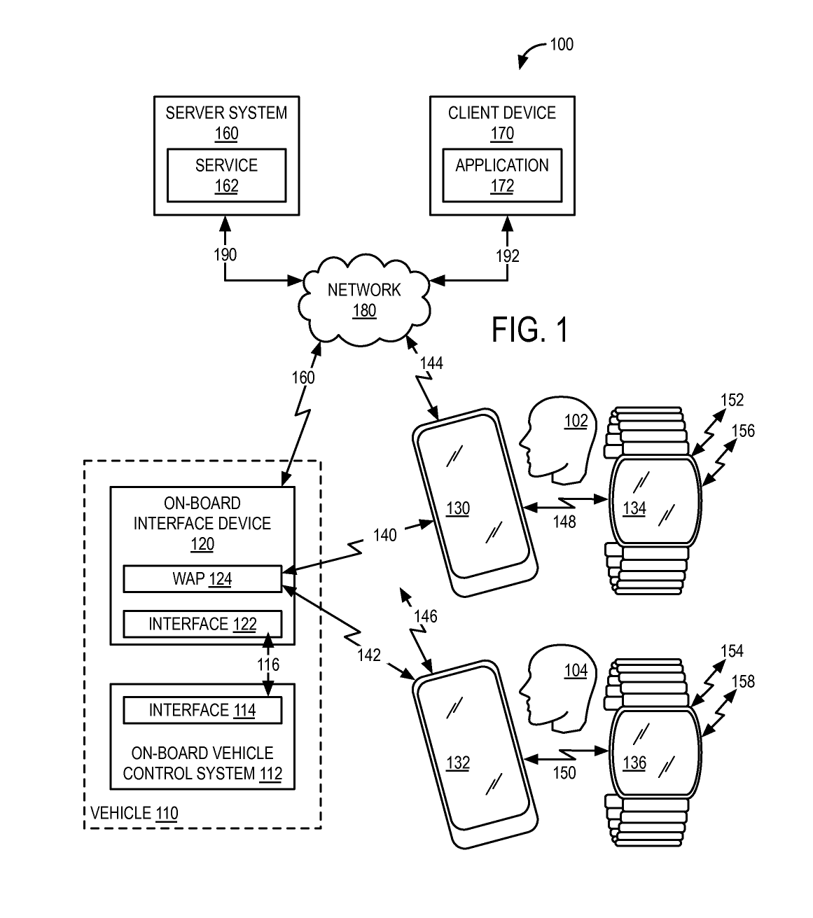

FIG. 1 is a schematic diagram depicting an example computing system 100. Within FIG. 1, a vehicle 110, represented schematically, includes an on-board vehicle control system 112 that measures, manages, records, and reports operation of the vehicle's various subsystems. Vehicle 110 is typically a ride-on vehicle that enables one or more passengers (e.g., passengers 102, 104) to be transported on-board the vehicle. Vehicle 110 may take a variety of different forms, including a land-based wheeled, rail, or track vehicle (e.g., car, truck, bus, tractor, train, locomotive, motorcycle, snowmobile, etc.), an aircraft (e.g., airplane, helicopter, etc.), a marine vessel (e.g., boat or personal watercraft), or other suitable vehicle type.

On-board vehicle control system 112 includes or otherwise hosts an on-board diagnostics service that is accessible via a data interface 114, which may be referred to as an on-board diagnostics interface. Vehicle 110 further includes and/or interfaces with an on-board interface device 120. In at least some implementations, on-board interface device 120 may take the form of an aftermarket electronic device (e.g., a computing device) that is installed by a vehicle owner, operator, or technician after purchase of the vehicle or at the time of purchase of the vehicle. As an example, the on-board interface device 120 may take the form of a standalone telematics control unit (TCU). As another example, on-board interface device 120 may form part of and/or be integrated with on-board vehicle control system 112.

On-board interface device 120 and on-board vehicle control system 112 may collectively form an on-board computing system of vehicle 110. On-board interface device 120 includes a data interface 122 for communicating with on-board vehicle control system 112 or portions thereof via data interface 114 of control system 112. Such communications, indicated schematically by communication flow 116, may be bidirectional between on-board interface device 120 and vehicle control system 112, or may be unidirectional from on-board vehicle control system 112 to on-board interface device 120 or from on-board interface device 120 to on-board vehicle control system 112.

As an example, data interface 114 of on-board vehicle control system 112 may take the form of a physical hardware data link connector or data port, such as ALDL, OBD-I, OBD-1.5, OBD-II, or other suitable data interface. In an example, data interface 114 may provide a link to vehicle's CANbus. Data interface 122 of on-board interface device 120 may take the form of a physical hardware data link connector or data port that corresponds to and mates with interface 114. On-board interface device 120 may be physically added to and/or removed from interfacing with on-board vehicle control system 112 at a boundary of data interfaces 114 and 122. In another implementation, communication flow 116 may take the form of a wireless communications link between data interface 114 and data interface 122. In this implementation, the data interfaces may include wireless transmitters and/or receivers, and associated electronic components supporting one or more wireless communications protocols.

In at least some use-scenarios, passengers residing on-board vehicle 110 may each carry, wear, or otherwise possess one or more personal electronic devices. Non-limiting examples of personal electronic devices include mobile computing devices, mobile communication devices, wearable electronic devices, handheld computing devices, laptop computing devices, mobile media devices, etc. In the example depicted in FIG. 1, a first passenger 102 possesses a first smartphone 130, and a second passenger 104 possesses a second smartphone 132. Smartphones 130, 132 are examples of a personal electronic device that may be carried by a passenger, including by hand, within a pocket of a garment, within or as a personal effect of the passenger, or may otherwise reside nearby or in close contact with the passenger while on-board the vehicle.

Also in the example depicted in FIG. 1, first passenger 102 possesses a first wearable device 134, and second passenger 104 possesses a second wearable device 136. Wearable devices 134, 136 are additional examples of a personal electronic device that may be worn by a passenger. Wearable devices include body-mounted wearable devices such as wristwatches, glasses, bands for the head, arm, leg, chest, ankle, or other body part, and body-implanted electronic devices. Wearable devices further include clothing-integrated or clothing-mounted wearable devices, such as sensor-integrated shoes, hats, helmets, or other garments, pocket-fob devices, and devices that clip onto or otherwise attach to articles of clothing.

In at least some implementations, a personal electronic device includes one or more sensors that obtain physiological measurements of a human subject. Non-limiting examples of physiological measurements, as used herein, include: (1) heart rate and/or respiration rate, (2) body or skin temperature, (3) blood sugar (e.g., glucose) level, (4) blood pressure level, (5) blood oxygen level, (6) physical activity level (e.g., step counting, cadence of body movement, level of body movement, whether body movement is occurring, etc.), (7) eye activity or state (e.g., dilated), or other suitable physiological measurements. These physiological measurements may be referred to as sensor measurements of a state of a human subject (or passenger within the context of a vehicle) or the passenger state.

In at least some implementations, one or more sensors of a personal electronic device may additionally or alternatively obtain measurements of: (1) position of the device (e.g., geolocation information obtained via GPS, access-point locating/triangulation, or other geolocation technology), (2) orientation of the device (e.g., relative to a gravity vector), (3) speed and/or heading of the device (e.g., collectively velocity), (4) acceleration and/or deceleration magnitude of the device and/or direction of acceleration and/or deceleration, (5) rate of change of acceleration and/or deceleration of the device, (6) route or path travelled by the device in two or three dimensional space, (7) time-based changes in orientation of the device, (8) ambient temperature and/or pressure at the device, (9) ambient noise in the vicinity of the device, (10) ambient light in the vicinity of the device, or other suitable measurements. These measurements may be referred to as sensor measurements of a state of the device or the device state.

Sensor measurements of device state and passenger state obtained by one or more sensors of a personal electronic device may be collected over time in the form of a time-based record of sensor measurements. Sensor measurements may be stored locally in data storage on-board the personal electronic device and/or may be transmitted over a wireless or wired communication link to a remote computing device. Non-limiting examples of sensors that may be incorporated into a personal electronic device to obtain the sensor measurements described herein include: (1) accelerometers, gyroscopes, and/or inertial sensors (e.g., collectively motion sensors), (2) tilt sensors, orientation sensors, and/or magnetic compass sensors, (3) optical sensors, (4) temperature sensors, (5) microphones, (6) geolocation sensors (e.g., GPS receiver and processing components), or other suitable sensors.

In an example, an optical sensor of a wearable device may be orientated toward the skin or body part of a human subject wearing the device, and the optical sensor may be used to obtain measurements of heart rate and/or respiration rate, eye activity or state, body or skin temperature, blood sugar, pressure, and/or oxygen levels, or other blood-based measurements. In another example, one or more accelerometers, gyroscopes, inertial sensors, tilt/orientation sensors, and/or geolocation sensors (e.g., GPS receiver and processing components) of a personal electronic device may be used to obtain measurements of a human subject's physical activity levels and a device/human subject's geolocation, orientation, velocity, acceleration/deceleration, rate of change of acceleration/deceleration, etc. In the case of wearable devices, measurements of device state provide additional measurements of passenger state within an environment, assuming that the passenger was wearing the wearable device at the time the measurements were obtained. In the case of other personal electronic devices, measurements of device state may provide reasonable approximations of passenger state within an environment, assuming that the passenger was holding, wearing, located nearby, and/or riding on the same vehicle as the personal electronic device.

A personal electronic device may take the form of a wireless device that communicates wirelessly with other devices using a wireless communications protocol. In the example depicted in FIG. 1, smartphones 130, 132 may communicate wirelessly with on-board interface device 120 as indicated by wireless links 140, 142, respectively. On-board interface device 120 is depicted as including a wireless access point 124, which may include a wireless transceiver and additional electronic components to support wireless communications with other devices. In an example, wireless access point 124 supports or otherwise provides a wireless local area network or wireless personal area network over which personal electronic devices may wirelessly communicate. Smartphones 130, 132 may additionally or alternatively communicate wirelessly with wireless access points located off-board vehicle 110 as indicated by wireless links 144, 146, respectively. As an example, communications over wireless links 144, 146 may be over public wireless networks (e.g., cellular networks) that provide access to a wide area network 180.

Smartphones 130, 132 may additionally or alternatively communicate wirelessly with other personal electronic devices, such as wearable devices 134, 136 as indicated by wireless links 148, 150, respectively. Wireless communications between personal electronic devices are typically over a wireless personal area network established between paired devices. Two or more personal electronic devices may be paired to established an on-going or session-specific session. As an example, smartphone 130 may be paired with wearable device 134, enabling the exchange of information over wireless link 148. Smartphone 132 may be paired with wearable device 136, enabling the exchange of information over wireless link 150.

Wearable devices 134, 136 may additionally or alternatively communicate wirelessly with on-board interface device 120 as indicated by wireless links 152, 154, respectively. Wireless links 152, 154 may take the form of direct communications with on-board interface device 120 over a wireless personal area network or a wireless local area network provided by wireless access point 124. Wearable devices 134, 136 may additionally or alternatively communicate wirelessly with wireless access points located off-board vehicle 110 as indicated by wireless links 156, 158, respectively. As an example, communications over wireless links 156, 158 may be over public wireless networks (e.g., cellular networks) that provide access to wide area network 180.

On-board interface device 120 may also communicate wirelessly with wireless access points located off-board vehicle 110 as indicated by wireless link 160. As an example, communications over wireless link 160 may be over public wireless networks (e.g., cellular networks) that provide access to wide area network 180. Communications between on-board interface device 120 and personal electronic devices 130, 132, 134, 136, etc. may be direct via a wireless personal area network or wireless local area network, or indirect via wide area network 180. In an example, wide area network forms part of the Internet, and may incorporate cellular network components. On-board interface device 120 may individually establish paired relationships with personal electronic devices or may provide open wireless access to any wireless device located within wireless range of wireless access point 124.

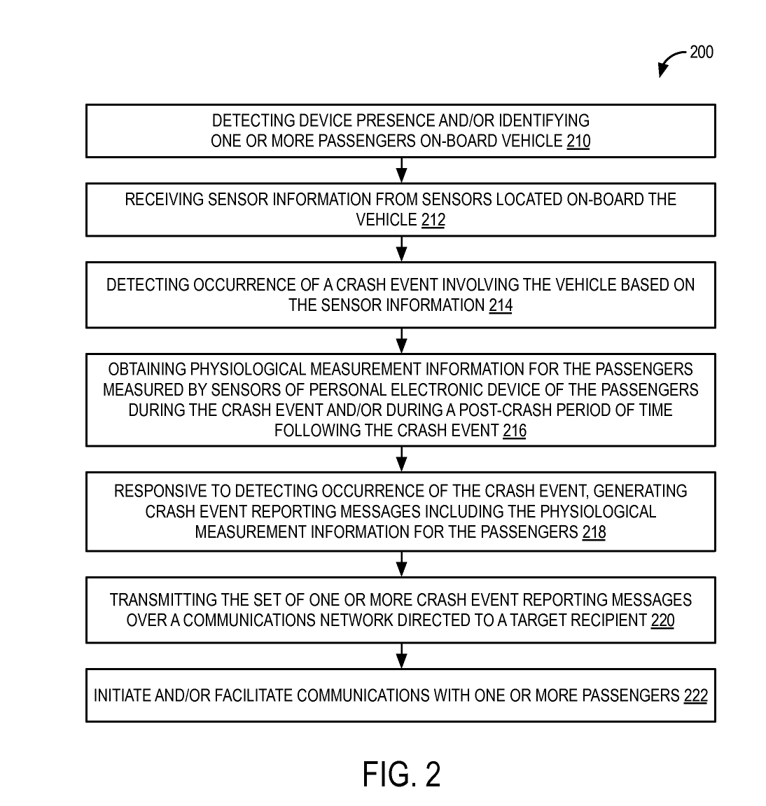

Wide area network 180 may enable on-board interface device 120 and the various personal electronic devices to communicate with remote computing devices or computing systems. As an example, server system 160 may provide or otherwise host a service 162 that is accessible to on-board interface device 120 and/or the personal electronic devices over wide area network 180 (e.g., including a wired or wireless communications link 190). As another example, client device 170 may include an application 172 that facilitates interaction with server system 160, on-board interface device 120, and/or the personal electronic devices over wide area network 180 (e.g., including a wired or wireless communications link 192). Various modes of communications between or among devices will be described in further detail with reference to FIGS. 2-5.

Wireless communications may be transmitted or received using any suitable wireless protocol. Non-limiting examples of wireless protocols include 4G LTE or 3G UMTS protocols as defined by the 3GPP standards body (typically for cellular components of wide area networks), Wi-Fi (typically for local area networks), Bluetooth (typically for personal area networks), Zigbee (typically for personal area networks), NFC (typically for personal area networks), etc. Wireless communications may include or utilize additional protocols at sub-layers of a protocol stack, including SMS, HTTP, HTTPS, TCP, UDP, OBD, Internet protocols, etc. Wide area network 180 may include or take the form of one or more wired and/or wireless communication networks. Network 180 may include one or more wide area networks such as the Internet, cellular backhaul networks, telephone networks, intermediate network devices, and edge devices such as wireless and/or wired access points, etc. Communications over wired communications links (e.g., within network 180) may utilize Internet protocols, as an example.

In at least some implementations, on-board interface device 120 may include one or more sensors to obtain sensor measurements. Non-limiting examples of sensors that may be incorporated into on-board interface device 120 include: (1) accelerometers, gyroscopes, and/or inertial sensors, (2) tilt sensors, orientation sensors, and/or magnetic compass sensors (3) optical sensors, (4) temperature sensors, (5) air pressure sensors, (6) microphones, (7) geolocation sensors, or other suitable sensors. Sensors of on-board interface device 120 may be used to obtain measurements of: (1) position of the device (e.g., geolocation information obtained via GPS, access-point locating/triangulation, or other geolocation technology), (2) orientation of the device (e.g., relative to a gravity vector), (3) speed and/or heading of the device (e.g., collectively velocity), (4) acceleration and/or deceleration magnitude of the device and/or direction of acceleration and/or deceleration, (5) rate of change of acceleration and/or deceleration of the device, (6) route or path travelled by the device in two or three dimensional space, (7) time-based changes in orientation of the device, (8) ambient temperature and/or pressure at the device, (9) ambient noise in the vicinity of the device, (10) ambient light in the vicinity of the device, or other suitable measurements.

Measurements obtained by sensors of on-board interface device 120 may be referred to as sensor measurements of a state of the on-board interface device or the device state. Measurements of the state of the on-board interface device may provide additional measurements of a state of vehicle 110, particularly when or if on-board interface device 120 is physically connected to a data interface (e.g., interface 114) of the vehicle or otherwise physically mounted to the vehicle. Sensors integrated with on-board interface device 120 may be referred to as vehicle-based sensors if or when the interface device is physically connected or mounted to the vehicle. In this case, sensor measurements obtained from accelerometers, inertial sensors, gyroscopes, tilt/orientation sensors of interface device 120 may be locked to the same reference frame as the vehicle. By contrast, personal electronic devices and/or on-board interface device 120 (when not physically connected or mounted to the vehicle) that are free to move within or relative to the vehicle, may obtain measurements that differ from the actual vehicle state. Sensor measurements of the state of the on-board interface device may be collected over time in the form of a time-based record of sensor measurements. Sensor measurements may be stored locally in data storage at on-board device 120 and/or may be transmitted over a wireless or wired communication link to a remote computing device.

Vehicle 110 may include one or more sensors integrated with the vehicle, and may be referred to as vehicle-based sensors. These sensors may form part of on-board vehicle control system 112. Vehicle 110 may include one or more of the sensors previously described with reference to on-board interface device 120. Additionally, vehicle 110 may include one or more special-purpose vehicle-based sensors, including: (1) impact sensors, (2) airbag deployment sensors, (3) antilock brake/traction control sensors, (4) engine/motor sensors (e.g., RPM, temperature, vehicle speed, fuel level, etc.), (5) exhaust system sensors, (6) tire pressure sensors, (7) accelerator pedal position sensors, (8) brake pedal position sensors, (9) door open/closed state sensors, or other vehicle-based sensors. Sensor measurements obtained by sensors integrated with vehicle 110 may be referred to as sensor measurements of vehicle state. Sensor measurements obtained by vehicle-based sensors may be collected over time in the form of a time-based record of sensor measurements. Sensor measurements may be stored locally in data storage at on-board vehicle control system 112 and/or may be transmitted over a wireless or wired communication link to a remote computing device. For example, control system 112 may transmit sensor measurements to on-board interface device 120 via interfaces 114, 122.

FIG. 2 is a flow diagram depicting an example method 200. Method 200 or a portion thereof may be performed by a computing system or a portion thereof, such as previously described computing system 100 of FIG. 1, for example.

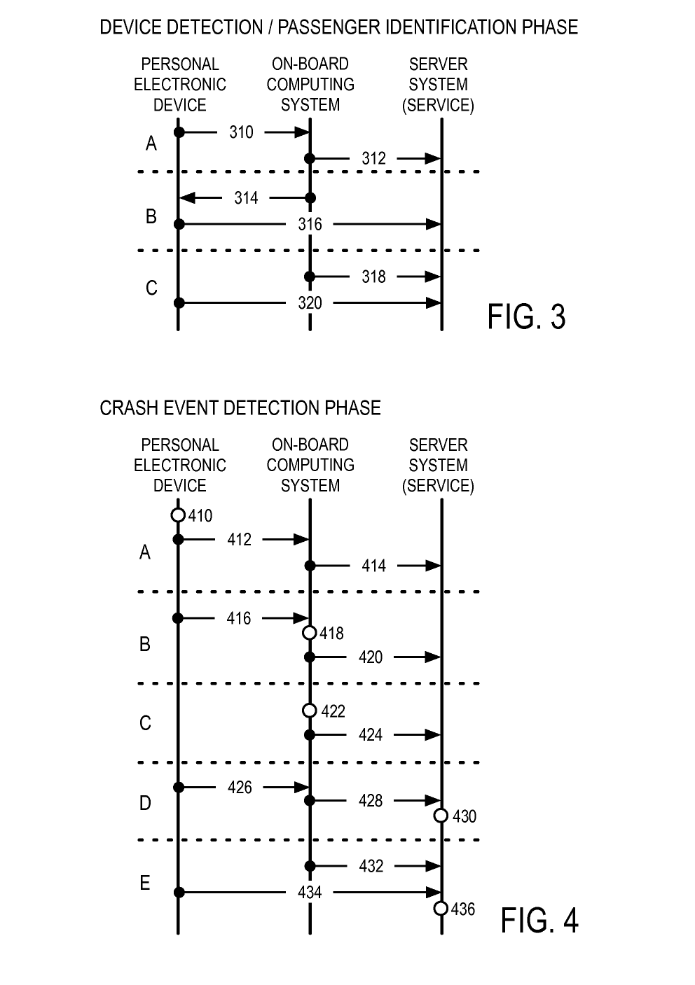

At 210, the method includes detecting device presence at a vehicle and/or identifying one or more passengers on-board a vehicle. Process 210 may form part of a device detection and/or passenger identification phase described in further detail with reference to FIG. 3.

Detecting device presence may include receiving a wireless communication from the wireless device via a wireless access point of the vehicle (e.g., typically a near-field or relatively short range wireless access point) that includes an identifier of the device or other distinguishing form of information. In an example, identifying one or more passengers on-board a vehicle may include: (1) receiving, via a wireless access point located on-board the vehicle, one or more wireless communications transmitted by one or more wireless devices, (2) obtaining one or more wireless device identifiers from the one or more wireless communications, for each wireless device identifier obtained from the one or more wireless communications, and (3) referencing a database system to obtain a user identifier associated with that wireless device identifier in which each user identifier identifies a passenger of the one or more passengers on-board the vehicle. In another example, identifying the one or more passengers on-board the vehicle includes initiating a prompt at one or more wireless devices associated with the vehicle in a database system, in which the prompt requests a user input identifying the one or more passengers on-board the vehicle. One or more wireless communications may be received from the one or more wireless devices that include or indicate the user input identifying the one or more passengers on-board the vehicle responsive to the prompt.

In another example, GPS or other geolocation information may be obtained from wireless devices indicating their respective geographic location, and may be correlated with GPS or other geolocation information obtained from the on-board interface device indicating a geographic location of the vehicle. Wireless devices that are located within a threshold proximity of the vehicle based on the GPS or other geolocation information received from each device may be identified as being located on-board the vehicle. In further examples, the threshold proximity must be maintained while the vehicle is moving to further demonstrate that the wireless devices are on-board the vehicle as opposed to being located nearby the vehicle. Detection based on GPS or other geolocation information may be performed by the server system in some implementations, such as server system 160 of FIG. 1 that hosts service 162.

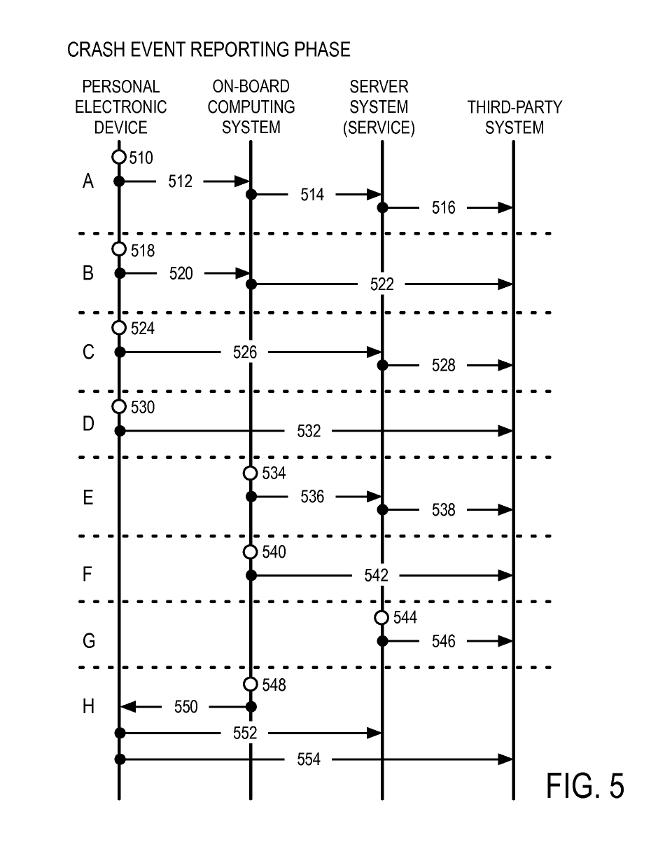

At 212, the method includes receiving sensor information from one or more sensors located on-board the vehicle. Sensors located on-board the vehicle include: (1) vehicle-based sensors integrated with the vehicle, (2) vehicle-based sensors integrated with an on-board interface device that physically interfaces with the vehicle (e.g., on-board interface device 120 of FIG. 1), and (3) sensors integrated with personal electronic devices carried by passengers on-board the vehicle. Sensor information may take the form of time-based sensor information captured by one or more sensors over a period of time. Sensor information may be received at one or more devices from one or more remote devices, as will be described in further detail with reference to FIGS. 4 and 5, for example.

At 214, the method includes detecting occurrence of a crash event involving the vehicle based on the sensor information. In an example, the sensor information may be obtained from one or more vehicle-based sensors and/or one or more personal electronic device-based sensors in the form of sensor measurements. In an example, one or more sensor measurements may be compared to one or more thresholds. If some or all of the sensor measurements exceed the one or more thresholds, then a crash event may be detected. If some or all of the sensor measurements do not exceed the one or more thresholds, then a crash event may not be detected. As an example, if an impact sensor or airbag deployment sensor indicates an impact event or that at least one airbag has been deployed, then a crash event is detected. As another example, if a vehicle deceleration or acceleration exceeds a threshold, then a crash event is detected. As yet another example, if a vehicle orientation exceeds a threshold (e.g., indicated as resting on its side or roof), then a crash event is detected.

Vehicle-based sensors, in contrast to sensors integrated with mobile personal electronic devices, are typically locked to a reference frame of the vehicle, thereby providing a more reliable representation of vehicle state. Sensors associated with personal electronic devices, on the other hand, may be worn or otherwise carried by passengers on-board the vehicle, and may be relatively disconnected from the vehicle reference frame. As an illustrative example, a passenger may drop a personal electronic device on a floor of the vehicle, which could be interpreted as a crash event of the vehicle. Hence, in at least some implementations, sensor measurements obtained from vehicle-based sensor may be used to detect a crash event. However, in other implementations, a crash event may be detected based on sensor measurements obtained from personal electronic devices in addition to or as an alternative to sensor measurements obtained by vehicle-based sensors. Processes 212 and 214 may form part of a crash event detection phase described in further detail with reference to FIG. 4.

At 216, the method includes, for each passenger of the one or more passengers identified on-board the vehicle, obtaining physiological measurement information for that passenger. The physiological measurement information (e.g., in the form of one or more sensor measurements) for each passenger may be measured by one or more sensors of a personal electronic device of that passenger. As previously described, physiological measurement information may include physiological measurements of: (1) heart rate and/or respiration rate, (2) body or skin temperature, (3) blood sugar (e.g., glucose) levels, (4) blood pressure levels, (5) blood oxygen levels, (6) physical activity levels (e.g., step counting, cadence of body movement, level of body movement, whether body movement is occurring, etc.), (7) eye activity or state, or other suitable physiological measurements.

In an example, the personal electronic device takes the form of a wearable electronic device that is worn by the passenger. In another example, the personal electronic device is a mobile communications devices or other suitable device that is carried by the passenger. The personal electronic device may be the same device or a different device used to wirelessly detect the presence of the passenger nearby or on-board the vehicle. The physiological measurement information for each passenger may be measured during a post-crash period of time following the crash event. Additionally or alternatively, the physiological measurement information for each passenger may be measured during the crash event. Additionally or alternatively, the physiological measurement information for each passenger may be measured prior to the crash event.

In at least some implementations, the method at 216 may further include obtaining device state measurement information (e.g., in the form of one or more sensor measurements) for each device detected at 210 from one or more sensors integrated with those devices during a post-crash period of time following the crash event, during the crash event, and/or prior to the crash event. In at least some implementations, the method at 216 may further include obtaining device state for the on-board interface device from one or more sensors integrated with the interface device during a post-crash period of time following the crash event, during the crash event, and/or prior to the crash event. As previously described, device state measurement information may include measurements of: (1) position of the device (e.g., geolocation information obtained via GPS, access-point locating/triangulation, or other geolocation technology), (2) orientation of the device (e.g., relative to a gravity vector), (3) speed and/or heading of the device (e.g., collectively velocity), (4) acceleration and/or deceleration magnitude of the device and/or direction of acceleration and/or deceleration, (5) rate of change of acceleration and/or deceleration of the device, (6) route or path travelled by the device in two or three dimensional space, (7) time-based changes in orientation of the device, (8) ambient temperature and/or pressure at the device, (9) ambient noise in the vicinity of the device, (10) ambient light in the vicinity of the device, or other suitable measurements.

In at least some implementations, the method at 216 may further include obtaining vehicle state measurement information from one or more sensors integrated with the vehicle and/or one or more sensors integrated with the on-board interface device during a post-crash period of time following the crash event, during the crash event, and/or prior to the crash event. As previously described, vehicle state measurement information may include measurements of: (1) position of the vehicle (e.g., geolocation information obtained via GPS, access-point locating/triangulation, or other geolocation technology), (2) orientation of the vehicle (e.g., relative to a gravity vector), (3) speed and/or heading of the vehicle (e.g., collectively velocity), (4) acceleration and/or deceleration magnitude of the vehicle and/or direction of acceleration and/or deceleration, (5) rate of change of acceleration and/or deceleration of the vehicle, (6) route or path travelled by the vehicle in two or three dimensional space, (7) time-based changes in orientation of the vehicle, (8) ambient temperature and/or pressure at the vehicle, (9) ambient noise in the vicinity of the vehicle, (10) ambient light in the vicinity of the vehicle, (10) airbag deployment state as measured via airbag deployment sensors, (11) antilock brake/traction control state as measured by antilock brake/traction control sensors, (12) engine/motor state as measured by engine/motor sensors (e.g., RPM, temperature, vehicle speed, fuel level, etc.), (13) exhaust system state as measured by exhaust system sensors, (14) tire pressure state as measured by tire pressure sensors, (15) accelerator pedal position or other state as measured by accelerator pedal sensors, (16) brake pedal position or other state as measured by brake pedal position sensors, (17) door open/closed state as measured by door sensors, or other suitable measurements.

At 218, the method includes generating a set of one or more crash event reporting messages. In at least some implementations, generating the set of crash event reporting messages may be performed responsive to and/or initiated upon detecting the occurrence of the crash event. In at least some implementations, the set of one or more crash event reporting messages may include the physiological measurement information for each passenger obtained at 216. Alternatively or additionally, the set of one or more crash event reporting messages may include device state measurement information and/or vehicle state measurement information obtained at 216.

Alternatively or additionally, the set of one or more crash event reporting messages may include passenger profile information, such as pre-defined biographical and/or medical records information for each passenger identified at 210. Passenger profile information may reside in data storage at a personal electronic device of the passenger and/or at a database system of the server system (e.g., service) with which the passenger has established a user account. The inclusion of passenger profile information in a reporting message may be dependent upon a user permission setting that permits or precludes the sharing of some or all of the passenger profile information. Users may access their profile information residing at the server system via their respective client devices over a communications network, and may modify, add, or remove biographical information, medical records information, and/or permissions via their respective client devices.

Alternatively or additionally, the set of one or more crash event reporting messages may include identifiers of the device or devices and/or the sensor or sensors from which the measurement information originated. As an example, some or all of the crash event reporting messages may include an identifier of the vehicle, an identifier of the on-board interface device, an identifier of one or more personal electronic devices identified as being on-board the vehicle at 210, and/or identifiers of individual sensors from which sensor measurements information contained in the reporting messages were obtained. Alternatively or additionally, the set of one or more crash event reporting messages may include identifiers of each passenger identified as being on-board the vehicle at 210.

Time-based sensor information may include timestamps associated with individual measurements or sets of measurements. Timestamps may be included with sensor measurements in the reporting messages. Time-based sensor information may include sensor measurements obtained prior to the crash event, during the crash event, and/or after the crash event. Individual measurements or sets of measurements may be associated with a measurement type identifier. Measurement type identifiers may be included with sensor measurements in one or more of the reporting messages. A crash event detected at 214 may be associated with a crash event identifier. The crash event identifier may be included in one or more of the reporting messages.

In at least some implementations, measurement information obtained from the various sensors may be processed into processed forms of the measurement information prior to or as a sub-process of generating one or more of the reporting messages. Processed forms of measurement information may take the form of summaries, averages, minimums, maximums, filtered data, metadata, or other suitable processed forms of data. Processed forms of measurement information may be included in one or more of the reporting messages. Non-limiting examples of metadata describing a crash event may include a quantity of passengers on-board the vehicle as identified at 210 or a quantitative and/or qualitative description of the crash event (e.g., an indication of an intensity or severity of the crash event or crash type).

At 220, the method includes, transmitting a set of one or more crash event reporting messages over a communications network directed to a target recipient. Within the context of a wireless device, the one or more crash event reporting messages may be wirelessly transmitted over a wireless network using a wireless protocol. Within the context of a wired device (e.g., a server system), the one or more crash event reporting messages may be transmitted over the wired network using any suitable protocol, including Internet protocols. The target recipient may be addressed by an IP address, email address, telephone number, or other suitable network addressable location, and messages may be communicated to a device that is associated with that network address.

In at least some implementations, transmitting the set of crash event reporting messages may be performed responsive to and/or initiated upon detecting the occurrence of the crash event. As an example, one or more crash event reporting messages may be pre-generated and stored locally in data storage on-board the vehicle until a crash event has been detected. In other examples, crash event reporting messages may be transmitted following generation of the reporting messages at 218. Processes 216, 218, and 220 may form part of a crash event reporting phase described in further detail with reference to FIG. 5.

A crash event reporting message may be referred to as belonging to a set of crash event reporting messages to emphasize the relatedness of the information contained therein to a particular crash event involving a particular vehicle. A set of crash event reporting messages may include two or more crash event reporting messages that are sequentially generated and transmitted over a period of time. In an example, following a crash event, a crash event reporting message may be generated and transmitted at a periodic rate (e.g., every 30 seconds, every minute, every hour, etc.), for a predefined or variable period of time (e.g., at least until emergency services have arrived or an emergency scenario has been concluded). In another example, messages may be generated based on the occurrence of an event, such as a door opening, an engine starting, a passenger beginning to move, a passenger that stops breathing, etc. Each crash event reporting message may contain a message identifier and/or timestamp (e.g., indicating a time of generation or transmission of the message) that indicates a relative position of the message with a sequence of messages.

Generating and transmitting crash event reporting messages may take place across two or more devices located along a communications path. As an example, a first device may generate and transmit an initial crash event reporting message to a second device that serves as the target recipient of the first device. The second device may receive, read, store, process, re-transmit, and/or repackage the initial message or information contained in the initial message. For example, the second device may add information to the initial message received from the first device and/or create one or more new messages that optionally contain information received via the initial message. The second device optionally generates one or more new crash event reporting messages containing or based on information received via the initial message, and transmits one or more crash event reporting message, including the initial message and/or one or more new messages, to another target recipient. In at least some implementations, an ultimate target recipient may take the form of emergency services and/or law enforcement services, or a service that handles emergency communications for emergency services and/or law enforcement services.

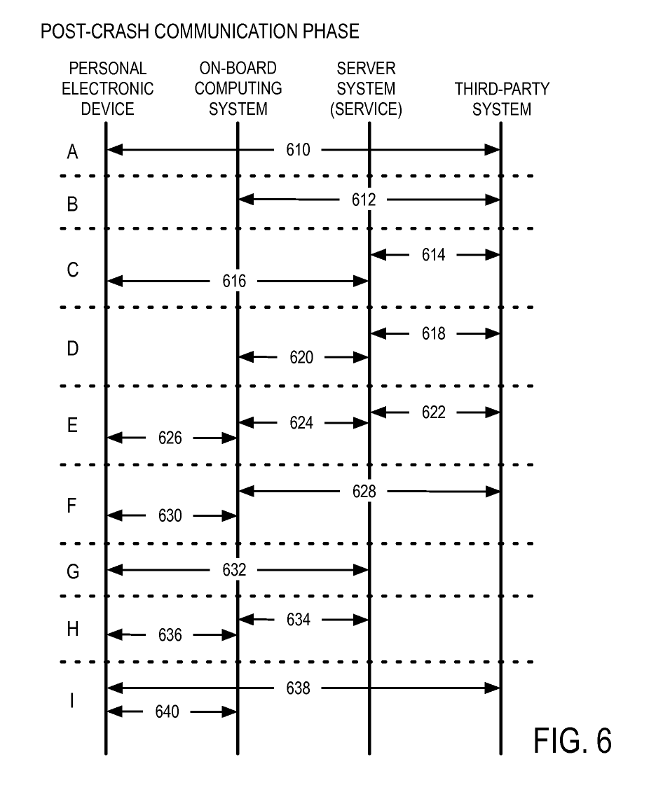

At 222, the method includes initiating and/or facilitating communications with one or more passengers of the vehicle. In at least some implementations, following detection of a crash event and/or reception of one or more crash event reporting messages, personnel associated with the target recipient may transmit communications to one or more devices located on-board the vehicle in an attempt to communicate with passengers. Such communications may include voice or text-based communications, and may include live or pre-recorded message content. Such communications may be bi-directional between personnel and passengers, or may be unidirectional from personnel to passengers or from passengers to personnel. Process 222 may form part of a communication phase described in further detail with reference to FIG. 6.

FIGS. 3-6 are flow diagrams depicting example interactions between several electronic devices of a computing system, such as computing system 100 of FIG. 1, for example. Each flow diagram of FIGS. 3-6 provide multiple modes of operation to achieve a particular result or complete a particular task. One or more modes may be used within the context of the same crash event, and the particular mode used may vary across devices depending on a variety of contextual factors. As an example, a type of network connectivity may influence the mode that is used. As another example, device capability may influence the mode that is used. The selection of which mode is used may depend on individual implementation.

FIG. 3 is a flow diagram depicting example interactions within a device detection and/or passenger identification phase according to various modes of operation A-C.

In mode A of the device detection and/or passenger identification phase, at 310, a personal electronic device transmits one or more wireless messages that are received by an on-board computing system of a vehicle. The on-board computing system includes an on-board interface device in an example, such as device 120 of FIG. 1. The on-board computing system receives the one or more messages transmitted at 310, and optionally detects presence of the personal electronic device based on information (e.g., an identifier, such as a wireless device identifier) contained in the one or more messages. In some implementations, the on-board computing system may further identify the passenger by referencing a database system that includes a passenger identifier (i.e., a user identifier) associated with the identifier of the personal electronic device. The on-board computing system may store the identifier of the personal electronic device and/or the passenger identifier (if known) locally in data storage in association with a travel event identifier. A travel event identifier may be used to distinguish different travel events that may include a different assortment of personal electronic devices and/or passengers. Travel events may be delineated based on on/off status of the vehicle, user-defined travel routes, detection of passengers boarding or deboarding the vehicle, and/or manual selection by a user input.

At 312, the on-board computing system transmits one or more wireless messages directed to a server system that hosts a service. The one or more wireless messages transmitted at 312 contain information reporting detection of the personal electronic device by the on-board computing system, and may further include an identifier of the on-board computing system, an identifier of the vehicle, the travel event identifier and/or passenger identifier (if known). The server system receives the one or more messages transmitted at 312, and associates the personal electronic device (e.g., via a device identifier) with the on-board computing system (e.g., via the identifier of the on-board computing system), the vehicle (e.g., via a vehicle identifier) with which the on-board computing system is associated. The server system may further associate the travel identifier with the personal electronic device and/or vehicle in the database system. In implementations in which the on-board computing system does not provide identification of passengers, the server system may reference a database system to identify the passenger associated with the identifier of the personal electronic device, and may optionally return an identifier of the passenger to the on-board computing system.

In mode B device detection and/or passenger identification phase, the roles of the on-board computing system and the personal electronic device are reversed. In this example, the on-board computing system transmits one or more wireless messages that are received by the personal electronic device at 314. The personal electronic device transmits one or more wireless messages to the server system at 316 to report detection of the personal electronic device being present at or nearby the on-board computing system. The one or more messages may include an identifiers of the personal electronic device, the on-board computing system, the vehicle, and/or the travel event identifier as previously described with reference to mode A.

In mode C device detection and/or passenger identification phase, the information previously described as being communicated to the server system is individually communicated by the personal electronic device and by the on-board computing system. In this example, the server system creates the association of the personal electronic device being present at or nearby the on-board computing system.

FIG. 4 is a flow diagram depicting example interactions within a crash event detection phase according to various modes of operation A-E.

In mode A of the crash event detection phase, a crash event is detected by a personal electronic device at 410. At 412, a set of one or more crash event reporting messages are generated and transmitted by the personal electronic device and are received by the on-board computing system. At 414, a set of one or more crash event reporting messages are transmitted by the on-board computing system (and optionally generated to include additional information and/or include retransmitted forms of the messages received at 412) and are received by the server system.

In mode B of the crash event detection phase, detection of a crash event is instead performed by the on-board computing system at 418 based on sensor measurements obtained by sensors of the personal electronic device that are transmitted by and received from the personal electronic device at 416 and/or based on sensor measurements obtained by sensors of the on-board computing system. Detection of the crash event is reported to the server system at 420 as a set of one or more crash event reporting messages.

In mode C of the crash event detection phase, a crash event is detected by the on-board computing system at 422 based exclusively on sensor measurements obtained by the on-board computing system, without referencing sensor measurements obtained from the personal electronic device. Such sensors may include sensors integrated with an on-board interface device and/or sensors integrated with the vehicle. Detection of the crash event is reported to the server system at 424 as a set of one or more crash event reporting messages.

In mode D of the crash event detection phase, a crash event is detected by the server system at 430 based on sensor measurements obtained from the personal electronic device and/or the on-board computing system. In this example, the personal electronic device reports sensor measurements to the on-board computing system at 426. At 428, the on-board computing system transmits sensor measurements received from the personal electronic device and/or sensor measurements obtained from sensors integrated with the on-board computing system, which are received by the server system.

In mode E of the crash event detection phase, sensor measurements are individually reported to the server system by the personal electronic device and the on-board computing system at 432 and 434. The server system detects the crash event at 436 based on the sensor measurements obtained from the on-board computing system and/or the personal electronic device. In still further modes of operations, the on-board computing system may report sensor measurements to one or more personal electronic devices, which in-turn either detect the crash event based on the sensor measurements received from the on-board computing system or transmit those sensor measurements to the server system.

FIG. 5 is a flow diagram depicting example interactions within a crash event reporting phase according to various modes of operation A-H.

In modes A-D of the crash event reporting phase, the crash even is detect by the personal electronic device at 510, 518, 524, and 530 respectively. In mode A, detection of the crash event is reported to the on-board computing system by the personal electronic device at 512 as a set of one or more crash event reporting messages. At 514, the on-board computing system reports the crash event to the server system as a set of one or more crash event reporting messages. At 516, the server system reports the crash event to a third-party system as a set of one or more crash event reporting messages. As previously discussed, each recipient of crash event reporting messages is a target recipient of another device, and each set of messages may include or may be based on information received from downstream devices. Mode B is similar to Mode A with the exception of the on-board computing system transmitting the set of crash event reporting messages directly to the third-party system as the target recipient, as indicated at 522. The reporting messages transmitted at 522 may be responsive to reporting messages received from the personal electronic device at 520. Mode C is also similar to Mode A with the exception of the personal electronic device transmitting the set of crash event reporting messages directly to the server system as the target recipient, as indicated at 526. The server system transmits a set of reporting messages at 528 to the third-party system responsive to the reporting messages received at 526. Mode D is also similar to Mode A with the exception of the personal electronic device transmitting the set of crash event reporting messages directly to the third-party system as the target recipient, as indicated at 532.

In Modes E, F, and H of the crash event reporting phase, crash event detection is performed by the on-board computing system. In Mode F, the crash event is detected by the on-board computing system at 534 based exclusively on measurements obtained by sensors integrated with the on-board computing system. At 536, a set of crash event reporting messages is transmitted by the on-board computing system to the server system. At 538, the server system transmits a set of crash event reporting messages to the third-party system responsive to the messages received at 536. Mode F is similar to Mode E with the exception of the on-board computing system transmitting a set of crash event reporting messages directly to the third-party system at 542 responsive to detection of a crash event at 540. In mode H, a crash event is detected by the on-board computing system at 548, and a set of one or more crash event reporting messages are transmitted from the on-board computing system to the personal electronic device at 550. In response to the messages received at 550, the personal electronic device transmits a set of one or more crash event reporting messages directly to the server system at 552 and/or directly to the third-party system at 554.

In mode G of the crash event reporting phase, the server system detects a crash event at 544, and reports the crash event to the third party system at 546 as a set of one or more crash event reporting messages.

FIG. 6 is a flow diagram depicting example interactions within a post-crash communication phase according to various modes of operation A-I.

In mode A of the post-crash communication phase, communications are established between the personal electronic device and the third-party system without traversing the on-board computing system or server system. In this example, a passenger may communicate with personnel of the third-party system via the personal electronic device.

In mode B of the post-crash communication phase, communications are established between the third-party system and the on-board computing system without traversing the server system or the personal electronic device. In this example, a passenger may communicate with personnel of the third-party system via the on-board computing system.

In mode C of the post-crash communication phase, communications are established between the third-party system and the personal electronic device via the server system without traversing the on-board computing system. In this example, a passenger may communicate with personnel of the third-party system via the personal electronic device.

In mode D of the post-crash communication phase, communications are established between the third-party system and the on-board computing system via the server system without traversing the personal electronic device. In this example, a passenger may communicate with personnel of the third-party system via the on-board computing system.

In mode E of the post-crash communication phase, communications are established between the third-party system and the personal electronic device via the server system and the on-board computing system. In this example, a passenger may communicate with personnel of the third-party system via the personal electronic device.

In mode F of the post-crash communication phase, communications are established between the third-party system and the personal electronic device via the on-board computing system without traversing the server system. In this example, a passenger may communicate with personnel of the third-party system via the personal electronic device.

In mode G of the post-crash communication phase, communications are established between the server system and the personal electronic device without traversing the on-board computing system. In this example, a passenger may communicate with personnel of the server system (e.g., the service) via the personal electronic device.

In mode H of the post-crash communication phase, communications are established between the server system and the personal electronic device via the on-board computing system. In this example, a passenger may communicate with personnel of the server system (e.g., the service) via the personal electronic device.

In mode I of the post-crash communication phase, communications are established between the third-party system and the on-board computing system via the personal electronic device with or without traversing the server system. In this example, a passenger may communicate with personnel of the third-party system via the on-board computing system.

In at least some implementations, the methods and processes, or portions thereof described herein may be tied to a computing system that includes one or more computing devices. Such methods and processes may be implemented as a computer-application program or service, an application-programming interface (API), a library, and/or other computer-program type.

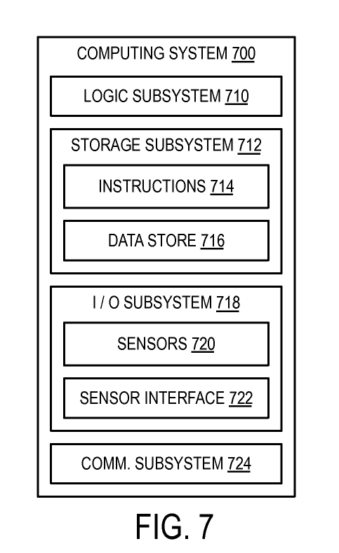

FIG. 7 is a schematic diagram depicting an example computing system 700 of one or more computing devices. Computing system 700 is a non-limiting example of example computing system 100 of FIG. 1. Computing system 700 may be configured to perform the methods and processes, or portions thereof described herein. Computing system 700 is shown in simplified form. Computing system 700 may take the form of one or more personal computers, server computers, wireless devices, personal electronic devices, and/or other computing devices.

Computing system 700 includes a logic subsystem 710 and a storage subsystem 712. Computing system 700 may further include an input/output subsystem 718, a communication subsystem 724, and/or other components not shown in FIG. 7.

Logic subsystem 710 may include one or more physical logic devices configured to execute instructions 714 stored or otherwise held in storage subsystem 712. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors (as an example of physical logic devices) configured to execute software instructions. Additionally or alternatively, the logic subsystem may include one or more hardware and/or firmware logic machines (as an example of physical logic devices) configured to execute hardware or firmware instructions. Processors of the logic subsystem may be single-core or multi-core, and the instructions executed thereon may be configured for sequential, parallel, and/or distributed processing. Individual components of the logic subsystem may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 712 includes one or more physical, non-transitory memory devices configured to hold instructions 714 executable by the logic subsystem in non-transitory form, to implement the methods and processes described herein. One or more physical, non-transitory memory devices of storage subsystem 712 may be configured to hold data in data store 716 (also referred to as data storage). When such methods and processes are implemented, the state of storage subsystem 712 may be transformed—e.g., to hold different data. Storage subsystem 712 may include removable and/or built-in devices. Storage subsystem 712 may include optical memory devices, semiconductor memory devices, and/or magnetic memory devices, among other suitable forms. Storage subsystem 712 may include volatile, nonvolatile, dynamic, static, read/write, read-only, random-access, sequential-access, location-addressable, file-addressable, and/or content-addressable devices. Aspects of logic subsystem 710 and storage subsystem 712 may be integrated together into one or more hardware-logic components. While storage subsystem 712 includes one or more physical devices, aspects of the instructions described herein alternatively may be propagated by a communication medium (e.g., an electromagnetic signal, an optical signal, etc.) that is not necessarily held by a physical device for a finite duration.

The terms “module,” “program,” and “engine” may be used to describe an aspect of computing system 700 implemented to perform a particular function. In some cases, a module, program, or engine may be instantiated via logic subsystem 710 executing instructions held by storage subsystem 712. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. A “service”, as used herein, may refer to an application program executable across multiple user sessions. A service may be available to one or more system components, programs, and/or other services. In some implementations, a service may run on one or more server-computing devices.

Input/output subsystem 718 may include or interface with one or more user-input devices such as a keyboard, mouse, touch screen, microphone etc. Input/output subsystem 718 may include or interface with one or more sensor devices (e.g., depicted as sensors 720 and/or including sensor interface 722 to interface with sensors), such as previously described herein. Input/output subsystem 718 may include or interface with one or more output devices such as a graphical display device, touch screen, audio speakers, etc.

Communication subsystem 724 may be configured to communicatively couple computing system 700 with one or more other devices. Communication subsystem 700 may include wired and/or wireless communication devices compatible with one or more different communication protocols. As non-limiting examples, the communication subsystem may be configured for communication via a wired or wireless wide area network, local area network, and/or personal area network. In an example, the communication subsystem may allow computing system 700 to send and/or receive messages to and/or from other devices via a communications network.

As described herein, a variety of information in the form of data may be measured, collected, received, stored, retrieved from storage, processed, analyzed, organized, copied, reported, and/or transmitted in raw and/or processed forms. Data includes a set of one or more values (i.e., data values) of one or more parameters or variables. Such values may be quantitate or qualitative in nature. Data may be represented by one or more physical quantities, attributes, or characteristics of one or more signals or object states.

An object state refers to a physical state of a tangible, physical object, such as a device or machine. Within the context of a computing system or other electronic system, an object state may include a value of a bit stored in a memory cell or other suitable bistable/multistable electronic circuit (e.g., flip-flop or latch) of a memory device. As an example, a value of a bit may be defined by a high or low physical voltage value of a memory cell, corresponding to values of 1 or 0 for the bit, respectively.

Data represented by one or more signals (i.e., data signals) may be propagated by a communication medium, in the form of electrical signals, electromagnetic signals, optical signals, etc. Data signals may be communicated over one or more wired and/or wireless communications links or paths. Data signals may take the form of or form part of a modulated signal or a non-modulated signal. Data signals may be formatted or otherwise organized into one or more messages, streams, packets, datagrams, and/or frames as defined by one or more communications protocols.

Data may be represented in a variety of digital and/or analog forms. Within the context of digital data, an object state or signal component representing an individual data unit may be observed or identified as having a discrete value of two or more discrete values. Within the context of analog data, an object state or signal component representing an individual data unit may be observed or identified as having a value within a range of non-quantized values.

A collection of data may take the form of a set instructions that are executable by a machine to perform one or more operations. Such instructions may be referred to as machine-readable instructions that direct the machine to perform one or more operations. A set of instructions may take the form of software or a portion thereof (e.g., a software component). Software may include firmware, an operating system, an application program or other program type, a software plug-in, a software update, a software module, a software routine, or other software component.

An organized collection of data may take the form of a database system or other suitable data structure (e.g., an electronic file). A database system includes one or more databases that define relationships and associations between and among data objects. As an example, a data object (e.g., a user identifier) that includes a set of one or more data values may be associated with one or more other data objects (e.g., a user setting). A database system may be integrated with or form part of a software component.

Data may include metadata that describes other data. Metadata describing the structure of other data, such as a relationship or association of data objects in a database may be referred to as structural metadata. Metadata describing the content of other data may be referred to as guide metadata. A collection of data may include metadata and other data described by that metadata.

The configurations and/or approaches described herein are exemplary in nature, and specific implementations or examples are not to be considered in a limiting sense, because numerous variations are possible. The specific methods or processes described herein may represent one or more of any number of processing strategies. As such, various acts illustrated may be performed in the sequence illustrated, in other sequences, in parallel, or in some cases omitted. Likewise, the order of the above-described processes may be changed. The subject matter of the present disclosure includes all novel and nonobvious combinations and subcombinations of the various methods, processes, systems and configurations, and other features, functions, acts, and/or properties disclosed herein, as well as any and all equivalents thereof.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and sub-combinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A method performed by a computing system, the method comprising:
identifying one or more passengers on-board a vehicle;
receiving sensor information from one or more sensors located on-board the vehicle;
detecting occurrence of a crash event involving the vehicle based on the sensor information;
for each passenger of the one or more passengers identified on-board the vehicle, obtaining physiological measurement information for that passenger measured by one or more sensors of a personal electronic device of that passenger during at least a post-crash period of time following the crash event; and
responsive to detecting the occurrence of the crash event, transmitting a set of one or more crash event reporting messages over a communications network directed to a target recipient, the set of one or more crash event reporting messages including the physiological measurement information obtained for each passenger of the one or more passengers identified on-board the vehicle.

2. The method of claim 1, wherein identifying the one or more passengers on-board the vehicle includes:
receiving, via a wireless access point located on-board the vehicle, one or more wireless communications transmitted by one or more wireless devices;
obtaining one or more wireless device identifiers from the one or more wireless communications; and
for each wireless device identifier obtained from the one or more wireless communications, referencing a database system to obtain a user identifier associated with that wireless device identifier in which each user identifier identifies a passenger of the one or more passengers on-board the vehicle.

3. The method of claim 2, wherein identifying the one or more passengers on-board the vehicle includes:
initiating a prompt at one or more wireless devices associated with the vehicle in a database system, the prompt requesting a user input identifying the one or more passengers on-board the vehicle; and
receiving one or more wireless communications from the one or more wireless devices, the one or more wireless communications indicating the user input identifying the one or more passengers on-board the vehicle responsive to the prompt.

4. Claim for identifying passengers by referencing a cloud-service database system that indicates passengers checked in at the vehicle.

5. The method of claim 1, wherein at least some of the one or more sensors located on-board the vehicle include one or more vehicle-based sensors integrated with the vehicle; and
wherein receiving the sensor information from the one or more sensors located on-board the vehicle includes receiving at least some of the sensor information from the one or more vehicle-based sensors integrated with the vehicle via an on-board interface device that interfaces with an on-board diagnostics service of the vehicle via an on-board diagnostics interface.

6. The method of claim 5, wherein the one or more vehicle-based sensors integrated with the vehicle include one or more of: an impact sensor, an airbag deployment sensor, an accelerometer, an inertial sensor, and/or a vehicle orientation sensor.

7. The method of claim 5, wherein at least some of the one or more sensors located on-board the vehicle include one or more sensors integrated with the on-board interface device; and
wherein detecting occurrence of the crash event involving the vehicle is based on at least some of the sensor information received from the one or more vehicle-based sensors integrated with the vehicle and at least some of the sensor information received from the one or more sensors integrated with the on-board interface device.

8. The method of claim 5, wherein detecting occurrence of the crash event involving the vehicle is performed by the on-board interface device; and
wherein transmitting a set of one or more crash event reporting messages over a communications network directed to a target recipient is performed by the on-board interface device, and includes wirelessly transmitting the set of one or more crash event reporting messages over a wireless communications network directed to the target recipient.

9. The method of claim 8, wherein the target recipient includes a server system hosting a service that transmits at least some of the physiological measurement information obtained for each passenger to emergency services and/or law enforcement services.

10. The method of claim 9, further comprising:
receiving the set of one or more crash event reporting messages at the server system;
adding medical records information to the set of one or more crash event reporting messages for each passenger identified on-board the vehicle or generating one or more new crash event reporting messages including the medial records information; and
transmitting the set of one or more crash event reporting messages with the medical records information added or the one or more new crash event reporting messages including the medical records information to emergency services and/or law enforcement services.

11. The method of claim 5, wherein obtaining the physiological measurement information for each passenger identified on-board the vehicle is performed by the on-board interface device, and includes receiving the physiological measurement information from each personal electronic over a wireless communications network.

12. The method of claim 1, further comprising:
generating the set of crash event reporting messages including the physiological measurement information for each passenger identified on-board the vehicle, and further including, in the set of one or more event reporting messages, one or more of: a passenger identifier of each passenger identified on-board the vehicle, a geolocation of the vehicle, an identifier of the vehicle, an identifier of each of the one or more personal electronic devices, and/or an indication of an intensity of the crash event.

13. The method of claim 1, wherein the physiological measurement information includes one or more of: heart rate, respiration rate, body or skin temperature, blood sugar level, blood pressure level, blood oxygen level, physical activity level, eye activity, and/or eye state.

14. The method of claim 1, wherein the physiological measurement information obtained for each passenger is further measured by the one or more sensors of the personal electronic device of that passenger during the crash event.

15. The method of claim 1, wherein at least some of the one or more sensors located on-board the vehicle include one or more sensors of at least one personal electronic device from which at least some of the physiological measurement information was obtained.

16. A computing system located on-board a vehicle, comprising:
an on-board interface device that interfaces with an on-board diagnostics service of the vehicle via an on-board diagnostics interface, the on-board interface device configured to:
wirelessly detect one or more personal electronic device located on-board the vehicle;
receive sensor information from one or more vehicle-based sensors integrated with the vehicle via the on-board diagnostics interface;
detect occurrence of a crash event involving the vehicle based on the sensor information received via the on-board diagnostics interface;
for each personal electronic device of the one or more personal electronic devices, receive physiological measurement information of a passenger measured by one or more sensors of that personal electronic device during at least a post-crash period of time following the crash event and/or during the crash event; and
wirelessly transmit a set of one or more crash event reporting messages over a wireless communications network directed to a target recipient, the set of one or more crash event reporting messages including the physiological measurement information received from each personal electronic device.

17. The computing system of claim 16, wherein the physiological measurement information includes one or more of: heart rate, respiration rate, body or skin temperature, blood sugar level, blood pressure level, blood oxygen level, physical activity level, eye activity, and/or eye state.

18. The computing system of claim 16, wherein the on-board interface device is further configured to generate the set of crash event reporting messages including the physiological measurement information for each personal electronic device identified on-board the vehicle, and further including, in the set of one or more event reporting messages, one or more of: a passenger identifier of each passenger identified on-board the vehicle, a geolocation of the vehicle, an identifier of the vehicle, an identifier of each of the one or more personal electronic devices, and/or an indication of an intensity of the crash event.

19. The computing system of claim 16, wherein the on-board interface device is further configured to obtain sensor information from one or more sensors integrated with the on-board interface device, and to detect occurrence of the crash event further based on the sensor information obtained from the one or more sensors integrated with the on-board interface device.

20. The computing system of claim 16, wherein the on-board interface device includes a computing device having a logic subsystem and a data storage subsystem in which the data storage subsystem has instructions stored thereon that are executable by the logic subsystem to detect occurrence of the crash event based on the sensor information received via the on-board diagnostics interface by comparing the sensor information to one or more thresholds.
